(19) United States
(12) Patent Application Publication
(10) Pub. No.: US 2006/0173685 A1
(43) Pub. Date: Aug. 3, 2006

(54) Method and apparatus for constructing new chinese words by voice input

(76) Inventors: Liang-Sheng Huang, Taipei City (TW); Ching-Ho Tsai, Huatan Township (TW); Jui-Chang Wang, Taipei City (TW); Jia-Lin Shen, Lujhou City (TW)

Correspondence Address: J C PATENTS, INC., 4 VENTURE, SUITE 250, IRVINE, CA, 92618, US

(21) Appl. No.: 11/133,647

(22) Filed: May 20, 2005

(30) Foreign Application Priority Data
Jan. 28, 2005 (TW) 94102596

(51) Int. Cl. G10L 15/04

(52) U.S. Cl. 704/254

(57) ABSTRACT

A method and apparatus for constructing new Chinese words by voice input is disclosed. The invention provides a method of adding new words to a speech recognition system, for example, a speaker-independent Chinese speech recognition system, for updating its vocabulary database. In the invention, voice signals indicating a description of Chinese characters/syllables are input sequentially, and feature parameters are derived from the voice signals. The feature parameters are compared with a description constraint unit to determine corresponding characters or syllables. The characters or syllables are stored in a storage unit. After confirmation by users, the characters or syllables are combined into a new word.

### CROSS-REFERENCE TO RELATED APPLICATION

This application claims the priority benefit of Taiwan application serial no. 94102596, filed on Jan. 28, 2005. All disclosure of the Taiwan application is incorporated herein by reference.

### BACKGROUND OF THE INVENTION

1. Field of Invention

The present invention relates to a method and apparatus for constructing new Chinese words by voice input. More particularly, the present invention relates to a method and apparatus for constructing new words by speaker-independent voice input, to a speaker-independent Chinese speech recognition system.

2. Description of Related Art

Speech recognition is a hot research and business issue. In speech recognition, feature parameters are extracted from the voice input and then compared with patterns in database. The patterns with high possibility are determined and output. However, speech recognition systems often encounter addition of new words. There are two kinds of systems for adding new words in Mandarin speech recognition, keyboard-strokes-based systems and training-based systems.

FIG. 1 shows a block diagram of a keyboard-strokes-based system, which includes a keyboard 100, a converter 102, a word model generator 104, a syllable-to-sub syllable model dictionary 106, a sub syllable model 108, and a speech recognition module 110. In adding new words or syllables into the system, new words are converted into syllables. The sub-syllable models of the corresponding syllables are constructed as a word model. The speech recognition module 110 adds the word model into a database. However, the keyboard-strokes-based system uses keyboard as inputting means, which is inconvenient.

FIG. 2 shows a block diagram of a training-based system, including a speech input unit 200, an extractor 202, a word training module 204, and a speech recognition module 206. The syllables spoken from a speaker are received by the speech input unit 200, and feature parameters thereof are extracted to establish new acoustic model of words under train. The speech recognition module 206 adds new acoustic models into a database. The training-based system needs to collect a large amount of database, and the speech recognition is speaker-dependent.

Although there are existing ways for adding new words, there are still no speaker-independent systems which add new words by purely voice input. Key strokes or voice feature collections are still needed.

### SUMMARY OF THE INVENTION

A method and apparatus for constructing new Chinese words by voice input, to a speech recognition system, for example, a speaker-independent Chinese speech recognition system, for updating its vocabulary database are provided. A user-friendly interface is provided in adding new Chinese words.

In one embodiment of the invention, a method and apparatus for constructing new Chinese words by voice input are provided. A Chinese word consists of several Chinese characters/syllables. Voice signals indicating the Chinese characters/syllables are input sequentially, and feature parameters are derived from the voice signals. The feature parameters are compared with a description constraint unit to determine corresponding characters or syllables. The characters or syllables, confirmed by the user, are stored in a storage unit. After all characters/syllable are input and confirmed by the user, the characters or syllables are combined into a new word.

Besides, an interface provided by the invention is user-friendly and speaker-independent.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a block diagram of a conventional keyboard-strokes-based system for constructing new Chinese words.

FIG. 2 shows a block diagram of a conventional training-based system for constructing new Chinese words.

FIG. 3 shows a block diagram of a voice-input based system for constructing new Chinese words, according to a preferred embodiment of the invention.

FIG. 4 shows a flow chart according to a method for constructing new Chinese words, according to a preferred embodiment of the invention.

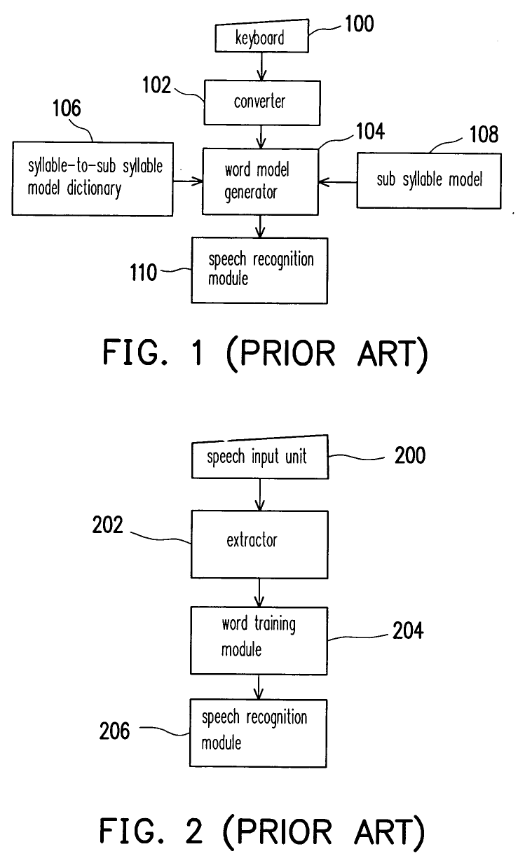

### DESCRIPTION OF THE PREFERRED EMBODIMENTS

Reference will now be made in detail to the present preferred embodiments of the invention, examples of which are illustrated in the accompanying drawings.

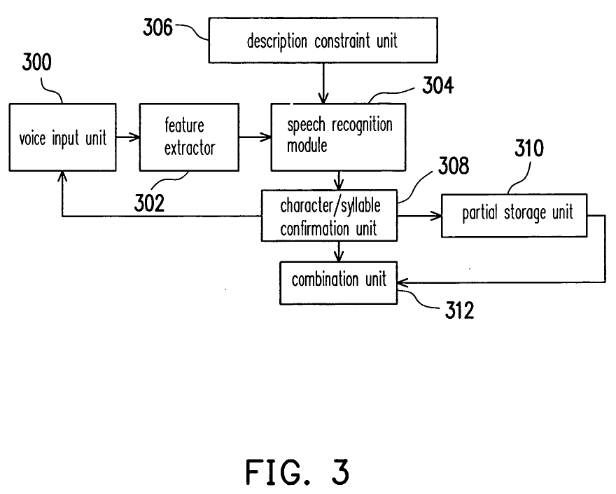

FIG. 3 shows a block diagram of a voice-input based system for constructing new Chinese words, according to a preferred embodiment of the invention. Please referring to FIG. 3, the system includes a voice input unit 300, a feature extractor 302, a speech recognition module 304, a description constraint unit 306, a character/syllable confirmation unit 308, a partial storage unit 310, and a combination unit 312.

The voice input unit 300, for example a microphone, receives voice signals from a user and converts into digital signals. The feature extractor 302 extracts feature parameters (or feature vectors) from the digital voice signals and outputs the feature parameters to the speech recognition module 304. The description constraint unit 306 includes acoustic models, lexical models, and language models. The speech recognition module 304 compares the feature parameters with the description constraint unit 306 to output possible result(s) to the character/syllable confirmation unit 308.

The character/syllable confirmation unit 308 displays possible result(s) to the users, and then the user decides whether there is a desired result. If yes, the desired result is stored into the partial storage unit 310. After character(s) in a new Chinese word are confirmed and stored in the partial storage unit 310, the character/syllable confirmation unit 308 informs the combination unit 312 to combine character(s) into a new Chinese word.

If the user rejects outputs from the character/syllable confirmation unit 308, then the user may try another description of the character/syllable into the voice input unit 300 for speech recognition and character/syllable combination. Or, if the user decides to give up establishment of Chinese new words, the partial storage unit 310 is reset.

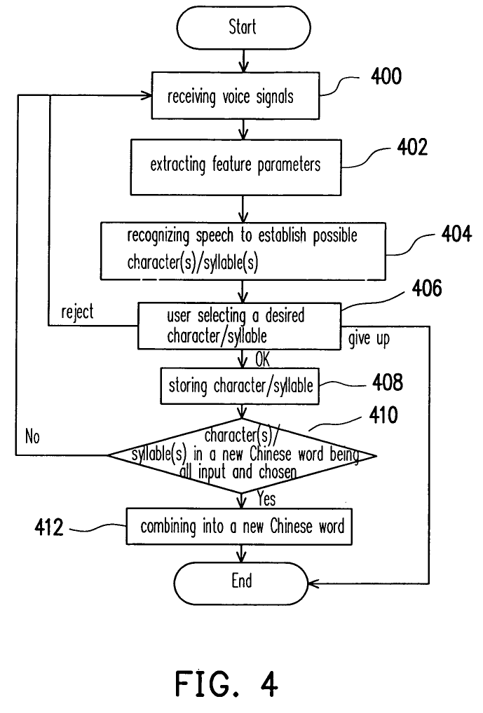

FIG. 4 shows a flow chart according to a method for constructing new Chinese words, according to a preferred embodiment of the invention. First, voice signals from a user are input and converted into digital voice signals, in step 400. Then, feature parameters are extracted from the digital voice signals, in step 402. Speech is recognized to establish possible character(s)/syllable(s), in step 404. The user selects the desired one from the possible character(s)/syllable(s), in step 406. If the user rejects, then the process returns to step 400 for a new voice input. Or, if the user gives up the addition of new Chinese words, the process is ended. Or, after the user chooses a desired character/syllable, the character/syllable is stored, in step 408. It is determined whether character(s)/syllable(s) in a new Chinese word is/are all input and chosen, in step 410. If yes, the character(s)/syllable(s) are combined into a new Chinese word, in step 412. If not, the process returns to step 400 for receiving next voice signals (indicating next character/syllable) from the user.

In step 400, the user describes the character/syllable, for example, by speaking a well-known phrase or word (for example, [symbol] in [symbol] speaking the Zhuyin spelling [symbol] or speaking the Pinyin spelling (t-a-i-2).

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A method of establishing Chinese words by voice input, comprising the steps of:
receiving a voice signal;
extracting a feature parameter from the voice signal;
determining a Chinese syllable or Chinese character based on an acoustic model;
storing the Chinese syllable or Chinese character; and
combining the Chinese syllable(s) or Chinese character(s) into a Chinese word.

2. The method of claim 1, wherein the voice signal indicates a description of existing Chinese phrase or word.

3. The method of claim 1, wherein the voice signal indicates a description of Zhuyin spelling.

4. The method of claim 1, wherein the voice signal indicates a description of Pinyin spelling.

5. The method of claim 1, wherein the storing step comprises the steps of:
receiving a confirmation signal; and
determining whether the confirmation signal indicates the Chinese syllable or Chinese character matched.

6. An apparatus for constructing a Chinese word, receiving a voice signal from a user to establish a Chinese word, the apparatus comprising:
a voice input unit, receiving the voice signal;
a feature extractor, extracting a feature parameter from the voice signal;
a description constraint unit, including an acoustic model, a lexical model and a language model;
a speech recognition model, comparing the feature parameters with the description constraint unit to output a corresponding Chinese syllable or Chinese character;
a syllable/character confirmation unit, receiving the corresponding Chinese syllable or Chinese character from the speech recognition model, and outputting the corresponding Chinese syllable or Chinese character confirmed by the user;
a partial storage unit, storing the corresponding Chinese syllable or Chinese character confirmed, by the user, from the syllable/character confirmation unit; and
a combination unit, combining the corresponding Chinese syllable(s) or Chinese character(s) from the partial storage unit into a Chinese word.

7. The apparatus of claim 6, wherein the voice signal indicates a description of existing Chinese phrase or word.

8. The apparatus of claim 6, wherein the voice signal indicates a description of Zhuyin spelling.

9. The apparatus of claim 6, wherein the voice signal indicates a description of Pinyin spelling.
